(19) United States
(12) Patent Application Publication
(10) Pub. No.: US 2012/0179983 A1
(43) Pub. Date: Jul. 12, 2012

(54) THREE-DIMENSIONAL VIRTUAL ENVIRONMENT WEBSITE

(76) Inventor: Martin LEMIRE, St-Charles-Borromee (CA)

(21) Appl. No.: 13/345,901

(22) Filed: Jan. 9, 2012

Related U.S. Application Data
(60) Provisional application No. 61/430,618, filed on Jan. 7, 2011.

(51) Int. Cl. G06F 3/01

(52) U.S. Cl. 715/757

(57) ABSTRACT

There is described a method and system for generating a 3D website. The 3D website is made up of three components, namely a 3D environment, a sound environment, and website content. The 3D environment is composed of 2D images that are positioned in a 3D space and navigable interactively. The website content is overlaid on top of the 2D images and may be global to the set of images, i.e. the website content appears on top of all images, or associated with only some of the images. The sound environment corresponds to sound zones which are linked to the website content and/or the 3D environment. Sound zones may be associated with parts of images, sets of images, user actions during navigation from one image to another, user actions during navigation within an image, website content, and/or user actions while navigating the website content.

### CROSS-REFERENCE TO RELATED APPLICATIONS

The present application claims priority under 35 USC 119(e) of U.S. Provisional Patent Application No. 61/430,618, filed on Jan. 7, 2011, the contents of which are hereby incorporated by reference.

### TECHNICAL FIELD

The present invention relates to the field of immersive 3D virtual environments.

### BACKGROUND OF THE ART

Immersive 3D virtual environments refer to any form of computer-based simulated 3D environment through which users can interact, either with one another or with objects present in the virtual world, as if they were fully immersed in the environment. One example of a type of virtual environment is a virtual representation of a house for sale whereby a user can navigate within the house virtually and see different views of the inside of the house. Street View™ from Google is another example of an immersive 3D environment, whereby the user can navigate the streets of a given geographical location and see the environment as if actually present.

These types of virtual 3D environments are used for various applications, such as gaming, real estate, and online shopping, and are often found to bring a significant visual impact. In most cases, the process necessary to create the 3D environment is a complex and costly one. Using a virtual 3D environment for online shopping or to sell a house is not usually within the means or the capabilities of a small store owner or a budding entrepreneur looking to showcase a product in the best way possible.

Therefore, there is a need to make virtual 3D environments more accessible to the general public such that various levels of users may take advantage of their benefits.

### SUMMARY

There is described a method and system for generating a 3D website. The 3D website is made up of three components, namely a 3D environment, a sound environment, and website content. The 3D environment is composed of 2D images that are positioned in a 3D space and navigable interactively. The website content is overlaid on top of the 2D images and may be global to the set of images, i.e. the website content appears on top of all images, or associated with only some of the images. The sound environment corresponds to sound zones which are linked to the website content and/or the 3D environment. Sound zones may be associated with parts of images, sets of images, user actions during navigation from one image to another, user actions during navigation within an image, website content, and/or user actions while navigating the website content.

In accordance with a first broad aspect, there is provided a computer-implemented method for generating a 3D website having a virtual three-dimensional environment composed of a plurality of images navigable in an immersive manner, website content, and sound, the method comprising executing on a processor program code for: building the three-dimensional environment with a plurality of two-dimensional images corresponding to views of the environment placed in a 3D space based on x, y, z coordinates, the plurality of images having a set of predetermined moves for navigation associated thereto; creating a sound environment for the three-dimensional environment by associating at least one sound zone with at least one part of at least one of the plurality of images, and setting sound parameters for each of the at least one sound zone; customizing website content separate from the images of the three-dimensional environment and configured to appear on at least one of the plurality of images; and generating the 3D website by integrating the three-dimensional environment, the sound environment, and the website content together for display, whereby the website content is overlaid on top of the three-dimensional environment.

In accordance with a second broad aspect, there is provided a system for generating a 3D website having a virtual three-dimensional environment composed of a plurality of images navigable in an immersive manner, website content, and sound, the system comprising: at least one computing device having a processor and a memory; a three-dimensional environment module stored on the memory and executable by the processor, the three-dimensional environment module having program code that when executed, builds the three-dimensional environment with a plurality of two-dimensional images corresponding to views of the environment placed in a 3D space based on x, y, z coordinates, the plurality of images having a set of predetermined moves for navigation associated thereto; a sound environment module stored on the memory and executable by the processor, the sound environment module having program code that when executed, creates a sound environment for the three-dimensional environment by associating at least one sound zone with at least one part of at least one of the plurality of images, and setting sound parameters for each of the at least one sound zone; a website content module stored on the memory and executable by the processor, the website content module having program code that when executed, customizes the website content separate from the images of the three-dimensional environment and configured to appear on at least one of the plurality of images; and an integration module stored on the memory and executable by the processor, the integration module having program code that when executed, generates the 3D website by integrating the three-dimensional environment, the sound environment, and the website content together for display, whereby the website content is overlaid on top of the three-dimensional environment.

In accordance with a third broad aspect, there is provided a computer readable medium having stored thereon program code executable by a processor for generating a 3D website having a virtual three-dimensional environment composed of a plurality of images navigable in an immersive manner, website content, and sound, the program code executable for: building the three-dimensional environment with a plurality of two-dimensional images corresponding to views of the environment placed in a 3D space based on x, y, z coordinates, the plurality of images having a set of predetermined moves for navigation associated thereto; creating a sound environment for the three-dimensional environment by associating at least one sound zone with at least one part of at least one of the plurality of images, and setting sound parameters for each of the at least one sound zone; customizing website content separate from the images of the three-dimensional environment and configured to appear on at least one of the plurality of images; and generating the 3D website by integrating the three-dimensional environment, the sound environment, and the website content together for display, whereby the website content is overlaid on top of the three-dimensional environment.

The term “objects” is intended to refer to any element making up a website or the 3D environment and should not be interpreted as meaning that object-oriented code is used.

### BRIEF DESCRIPTION OF THE DRAWINGS

Further features and advantages of the present invention will become apparent from the following detailed description, taken in combination with the appended drawings, in which:

FIG. 1 is a screenshot of a virtual 3D website in accordance with one embodiment;

FIG. 2 is the screenshot of FIG. 1 with directional markers overlaid onto the displayed image;

FIG. 3 is a schematic illustration of the layers making up the virtual 3D website;

FIG. 4 is a flowchart illustrating a method for providing a virtual 3D website, in accordance with one embodiment;

FIG. 5 is a flowchart of the step of building a 3D environment from FIG. 4, in accordance with one embodiment;

FIG. 6 is a flowchart of the step of adding sound to the 3D environment from FIG. 4, in accordance with one embodiment;

FIG. 7 is a schematic illustrating conceptually the association of sound zones with images, in accordance with one embodiment;

FIG. 8 is a flowchart of the step of customizing website content from FIG. 4, in accordance one embodiment;

FIG. 9 is a flowchart of the step of integrating 3D, sound and content from FIG. 4, in accordance with one embodiment;

FIG. 10 is a flowchart illustrating loading, executing and navigating the virtual 3D website, in accordance with one embodiment;

FIG. 11a is a flowchart illustrating a parallel object management process, in accordance with one embodiment;

FIG. 11b is a flowchart illustrating a parallel sound management process, in accordance with one embodiment;

FIG. 12 is a block diagram of a network for using the virtual 3D website, in accordance with one embodiment;

FIG. 13 is a block diagram of an exemplary server from the network of FIG. 12; and

FIG. 14 is a block diagram of an exemplary application from the server of FIG. 13.

It will be noted that throughout the appended drawings, like features are identified by like reference numerals.

### DETAILED DESCRIPTION

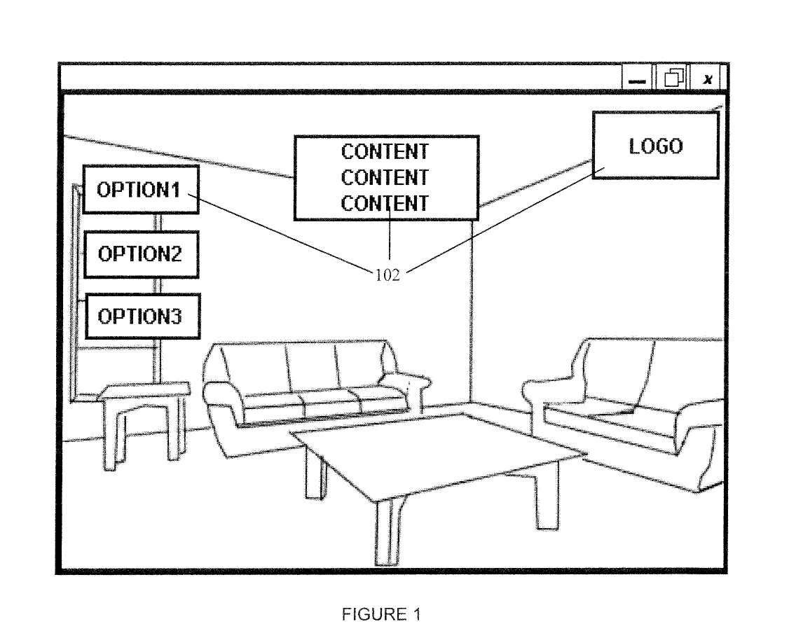

FIG. 1 is an exemplary illustration of a fully integrated virtual 3D environment website. The image in this example is a living room of a house for sale. The image of the living room is created using a method that will be described in more detail below. The user may navigate through the living room as well as other rooms of the house using an input device, such as a mouse, a keyboard or a touch screen. The commands sent through the input device will control the perspective of the image as if the user were fully immersed in the environment and moving around therein.

The images used for the fully immersive virtual visit of the house are geo-referenced and may cover about 360° of a view. The user may therefore rotate on himself and see the various views available from a given point. The user may also move forwards, backwards, left, right, up, down, spin left, and spin right. All of these possible moves are controlled by the user as he or she navigates through the virtual 3D environment. As the user moves beyond a given view and to another view including other images, the images change in a fluid manner. For example, if the user were to enter from the left side of FIG. 1 to explore the living room of the house, the view would change to a 3D virtual image of the living room from the perspective of a person standing at the given position and looking into the room. The user may navigate in this room using the various moves available to him or her.

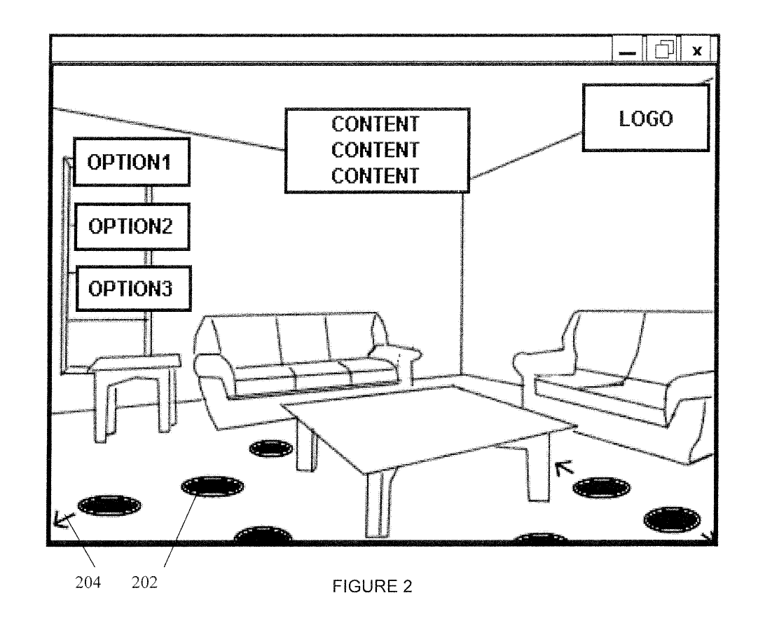

FIG. 2 is another exemplary embodiment of the 3D living room, whereby markers 202 are present to indicate the different positions available to the user. The user can move from one marker 202 to another and is cognizant of a position from which the view is shown. The user can also more easily recognize the paths that may be used for the navigation. The arrows 204 adjacent to the markers 202 show that other points of view are available for navigation if the user moves in the direction of the arrow 204.

A sound environment is overlaid onto the virtual 3D environment to enhance the user's experience as he or she navigates therein. For example, footsteps may be heard as the user advances through the environment. If the user walks by an open window, the sound of chirping birds may be provided. A fireplace may be accompanied by crackling fire sounds, or a general light background music appropriate for the setting may be used. The sound environment is customized by the user and combined with the 3D environment such that they work together to create a fully immersive and realistic visit.

Also shown in FIGS. 1 and 2 is the web content 102 overlaid onto the virtual 3D view. Similarly to a typical website, a set of interconnected Web pages, usually including a homepage and generally (but not necessarily) located on a same server, are prepared and maintained as a collection of information by a person, group, or organization. The interconnected Web pages may be navigated through using various hyper-links or menus.

These hyperlinks or menus are represented in FIGS. 1 and 2 by “option 1”, “option 2”, “option 3”. More or less than three links or menus may be provided on the website, as will be understood below, and may be used in various ways. For example, one or more of the “option” tabs may dictate the content illustrated at the top of the screen. In the example illustrated, the content may be information about the house being visited, such as pricing, dimensions, etc. The content may also be contact information for inquiring with the seller. In this example, selecting “option 1” results in information about the house being displayed in the “content” box and selecting “option 2” results in information about the seller being displayed in the “content” box. Alternatively, more than one “content” box may be displayed at a time, each “content” box being associated with a given “option” tab.

In another example, one or more of the “option” tabs may allow the user to navigate between floors or rooms of a given house, or between different houses. In this example, the “option 1” tab may result in a pull-down menu with the various rooms/floors and selecting one of the rooms/floors will cause the virtual 3D environment displayed to change to the selected room/floor of the house. The “option 2” tab may also result in a pull-down menu with other houses, identified by address or another parameter, and selecting one of the other houses causes the virtual 3D environment displayed to change to a room or floor of the newly selected house. The user can then navigate through this newly selected house in the same manner as described above.

The layout of the website content, including the number and disposition of the hyperlinks and/or menus, the number and disposition of content boxes, and the inclusion and disposition of other content, such as a company logo, are all variable and may be customized by the user.

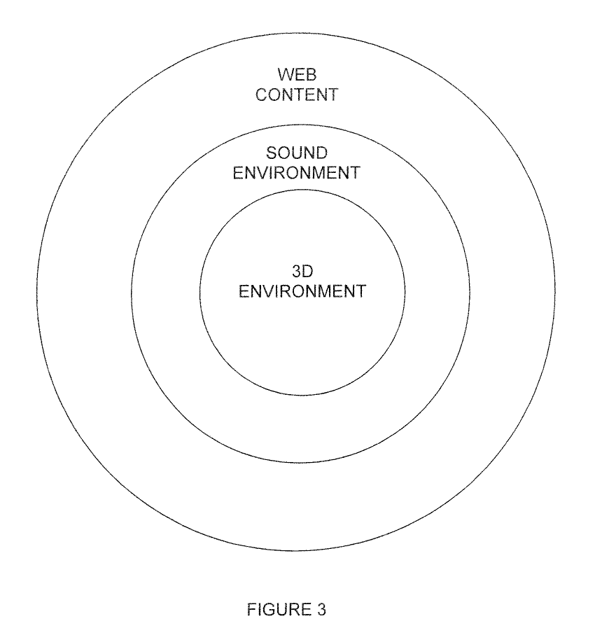

FIG. 3 is a schematic illustration of the various layers involved in the generation of the virtual 3D website. Each layer is created in a customized manner and overlaid onto the previous layer. The customization and integration of the layers is performed using the methods described below.

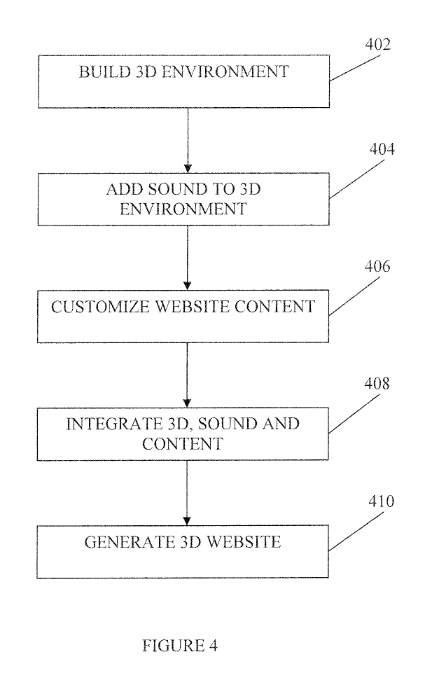

FIG. 4 is a method for generating a virtual 3D website in accordance with one embodiment. In a first step 402, a 3D environment is built. The 3D environment corresponds to the views that will be displayed to the user when navigating through the website. All pages of the website may be composed of 3D views, either of a same environment with different perspectives (ex: one house, different floors) or of different environments (ex: different houses). The 3D environment may be an actual store where products are sold (ex: flower shop) and the products are on display in the store, or it may be the product itself (ex: house for sale).

In a second step 404, a sound environment is added to the 3D environment. The sound environment is used to enhance the immersive visit of the 3D environment. In a third step 406, website content is customized. Similarly to creating a standard website, the user will decide how many Web pages will be interconnected and available on the website, how the user will navigate from one page to another, the content displayed on each page, the disposition of the content on each page, etc.

In a fourth step 408, the 3D environment, the sound environment, and the website content are integrated together. The virtual 3D environment website may then be generated 410.

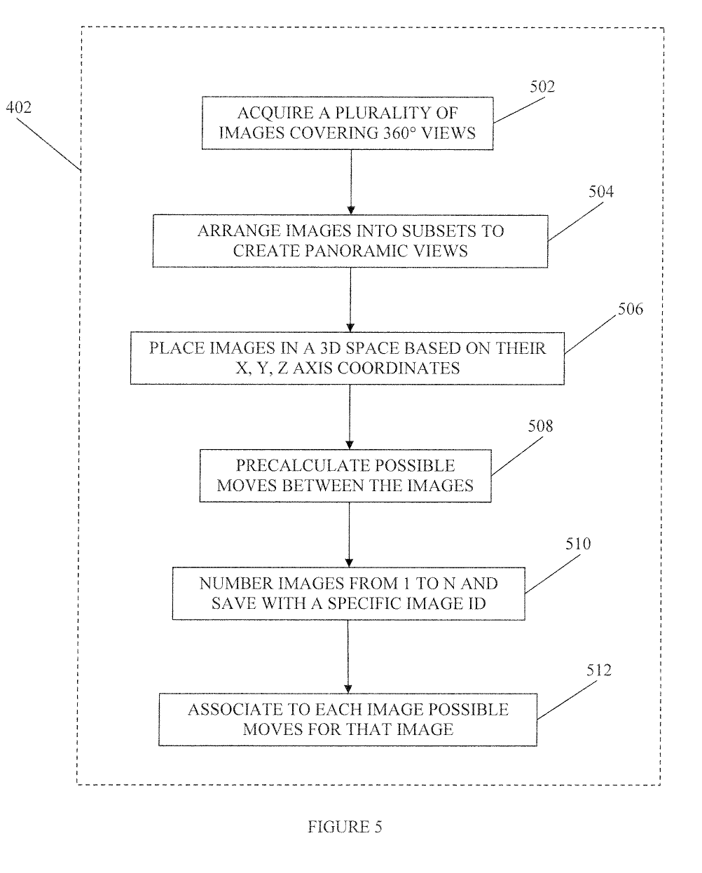

FIG. 5 is a flowchart illustrating in more detail step 402, whereby the 3D environment is built. The 3D environment is composed of a given number of images, pictures or rendered views. Therefore a first step 502 comprises acquiring a plurality of images covering 360° views. The images are organized into subsets to create panoramic views 504. Each panoramic view represents 360° and each image in a panoramic view represents a fraction of the 360° view. In one embodiment, approximately 24 pictures are used per panoramic view, each image representing approximately 15° of the view. When using photographs, each set of images are acquired using a camera that is rotated about a vertical axis at a given position. All pictures used for a given 3D environment should be shot in a similar manner, namely same first orientation and moving in a clockwise direction. The camera is moved a predetermined distance, such as a few inches, a foot, two feet, etc, and another set of images are taken for a second panorama. The 2D images are stored in one or more databases with information such as an image ID, an (x, y, z) coordinate, a camera angle, and a camera inclination, to allow them to be identified properly with respect to a 3D space 506. The same procedure may be used with rendered views, whereby one might imagine a virtual camera is rotated about a vertical axis to acquire the views.

The user may navigate through the environment using an input device such as a mouse, a keyboard or a touch screen. The commands sent through the input device will control the perspective of the image as if the user were fully immersed in the environment and moving around therein. The possible moves available for each image may be precalculated 508. Table 1 is an example of a set of precalculated moves.

TABLE 1

| ID | MOVE | DESCRIPTOR | COMMENT |
|---|---|---|---|
| 1 | FORWARD | 0 | 0 DEGREES IN FIRST |
| | | | QUADRANT, X AXIS |
| 2 | RIGHT | 90 | 90 DEGREES, Y AXIS |
| 3 | BACKWARD | 180 | 180 DEGREES, X AXIS |
| 4 | LEFT | 270 | 270 DEGREES, Y AXIS |
| 5 | SPIN RIGHT | P90 | TURN RIGHT ON SAME PANO |
| 6 | SPIN LEFT | P270 | TURN LEFT ON SAME PANO |
| 7 | UP | UP | GO UP, Z AXIS |
| 8 | DOWN | DOWN | GO DOWN, Z AXIS |

Each image is numbered from 1 to N and saved with a specific ID 510. This ID is used to jump from one image to another. For example, to jump to image ID 5, the image to display may be found at: <web root>\ProjectABC\I5.jpg. The set of precalculated moves is associated with each image 512. In one embodiment, this association may be done by providing a separate .txt file for each image, and the precalculated moves are in the .txt file. In another embodiment, the precalculated moves are stored in the actual image file, for example by using an EXIF parameter of the image.

A 3D environment may contain a lot of images, sometimes more than 30,000. Preloading into arrays all the directional movement possibilities can take a lot of time on the web. To avoid having to load all the data into arrays, an http request may be used to get this information for each image. In the case of a separate .txt file, this means that when an http request is sent to get an image, for example image I232.jpg, another http request is sent at the same time to get the associated text file I232.txt. Asynchronous communication may be used. The player displays the image and loads in the background the corresponding .txt file. Arrows or other types of markers may be displayed on the image showing all of the available moves. When a user presses a key to go in a given direction, the player looks in the .txt file, gets the corresponding image ID to jump to, loads it and its corresponding .txt file, and displays the new image. If the precalculated moves data is embedded directly in the image file, then a second http request is not needed as all necessary information is found in the I232.jpg file.

A configuration file containing the source code of the 3D environment may be an ASCII file or any other type of file that can easily be read by any text editor. This is the first file that is loaded when beginning an immersive visit. Many features and functionalities are available in the configuration file. In addition to navigating through images, attaching actions on key/mouse clicks on a given image area is also provided therein. Examples of possible actions are jumping to an image, opening a webpage, starting a sequence, loading a new project, etc.

In order to manage navigation of the user through the 3D environment, the 2D images may be grouped by panorama, whereby each panorama may be referenced using a panorama ID and an (x, y, z) coordinate. Various attributes of the panorama may also be used for indexing purposes. For each panorama, all 2D images corresponding to the (x, y, z) coordinate are grouped together and may be referenced using an image ID, a camera angle, and an inclination angle. Indexing of the panoramas is done with multiple structures used to identify either a given panorama or a given image. Hashing tables, look-up tables, 3D coordinates, and other tools may be used for indexing and searching.

The panoramas may be geo-referenced in 2D by ignoring the z coordinate. For example, when the panoramas of a multi-story building are geo-referenced, the stories may be placed side-by-side instead of stacked and a “jump” is required to move from one story to another. The stories may also be connected by stairs, which may be represented by a series of single-image panoramas, thereby resulting in unidirectional navigation. One series may be used for climbing up while another series may be used for climbing down. The series of single-image panoramas may also be geo-referenced in a side-by-side manner with the stories on a same 2D plane.

In one embodiment, a link between stories (or between series/sets of panoramas) may be composed of a jump from a lower story to an upwards climbing single-image panorama series, a jump from the upwards climbing single-image panorama series to the upper story, a jump from the upper story to a downwards climbing single-image panorama series, and a jump from the downwards climbing single-image panorama series to the lower story. In one embodiment, the stairs may be climbed backwards as well, therefore requiring additional jumps.

Jumps to go from an image in a first panorama series to an image in a second panorama series may be defined as links between an originating image and a destination image. For example, when receiving a request to jump from an image in a first panorama to an image in a second panorama, the panorama comprising the originating image is identified. The originating image itself is then identified in order to determine the angle of the originating image. This angle is used to provide the destination image with a same orientation, in order to maintain fluidity. The orientation of the user for the motion (i.e. forwards, backwards, lateral right, lateral left) is determined. The appropriate destination image may then be identified.

Jumping from one image to another image in a same panorama, and general navigation from panorama to panorama within a same set of panoramas may be managed in a similar manner. For example, when receiving displacement instructions that require displacement from one panorama to another, there may be more than one possible panorama for displacement. Once the identification which panoramas are available for displacement is performed, the one that is the most suitable may be chosen. When identifying possible panoramas for displacement, neighboring panoramas are looked for. This may be done by determining which panoramas are within a predetermined range of an area having a radius “r” and a center “c” at coordinate (x, y, z). The range is set by allocating boundaries along the x-axis from x+r to x−r, along the y-axis from y+r to y−r, and along the z-axis from z+r to z−r. For each whole number position along each one of the axes, it becomes possible to determine whether there exists a panorama that corresponds to the (x, y, z) coordinate.

An area on an image may be associated to a given action with a link. The link can be invisible or visible (displayed to the user). Position of the link on the image may be defined by X, Y coordinates and width and height of the zone. The action of a link can be automatically triggered by a request for a given direction (key press or click of the mouse on the zone) or by any other manner. In the configuration file, a global link may be represented by a string with the following syntax: X, Y, X2, Y2, IdPoint, ACTION, PARAM2, COMKEY, PARAM2, IMAGE, GROUP, LABEL. Scope of the links found in the configuration file are global, meaning that they are applied to all images. Table 2 illustrates some of the values that can define a link.

TABLE 2

| Parameter | Value | | |
|---|---|---|---|
| X, Y | Define X, Y coordinate of the zone | | Upper left |
| | | | corner start at |
| | | | 0, 0 (x, y) |
| X2, Y2 | Define X, Y coordinate of the zone | | Lower rigth corner |
| IdPoint | Id of an html popup to display on mouse over the zone. The html code | | |
| | to display in a popup is taken in section [Points] of AVW file for the | | |
| | current id preceding by the letter “p” | | |
| ACTION | Action to perform on the zone when user click on it with the mouse | | |
| | Action Id | Description | |
| | 1 | No action | |
| | 2 | Jump to an image id | |
| | 3 | Load new AVU3d AVW file and jump | |
| | | to an image id | |
| | 4 | * reserved * | |
| | 5 | Start a sequence file | |
| | 6 | Open an HTML document in a new | |
| | | browser | |
| | 7 | * reserved * | |
| | 8 | * reserved * | |
| | 9 | * reserved * | |
| | 10 | * reserved * | |
| | 11 | Jump to an image with a given altitude | |
| PARAM1 | This parameter depends of the action. PARAM2 is also use for action | | |
| | that needs more than one parameter. | | |
| | Action | Value | |
| | 2 | Id of the image to jump to | |
| | 3 | Id of the image to jump to in the new project define in | |
| | | PARAM2 | |
| | 11 | Altitude of the image to jump to | |
| | For all others action, PARAM1 is empty. | | |
| COMKEY | Attached a direction movement (example: an arrow key pressed) to | | |
| | trigger the action. If no COMKEY than the action is only triggered by | | |
| | a mouse click on the zone. If a COMKEY is defined, click with the | | |
| | mouse still trigger the action but the attached movement will also do. | | |
| | Movement Id | Description | |
| | 0 | No movement | |
| | 1 | Forward2 | |
| | 2 | Rigth | |
| | 3 | Backward | |
| | 4 | Left | |
| | 5 | Up | |
| | 6 | Down | |
| | 7 | Spin Rigth | |
| | 8 | Spin Left | |
| PARAM2 | This parameter depends of the action. PARAM1 is also use for action | | |
| | that needs more than one parameter. | | |
| | Action | Value | |
| | 3 | Name of a AVU3d project (AVW file) without the | |
| | | path. The file can be found in the <webroot> | |
| | | directory. | |
| | | Example: | |
| | | MyNewProject.avw | |
| | | PARAM1 defines the image to jump to | |
| | 5 | Name of a sequence file to play. | |
| | | A sequence file is an ascii file with a serie of image | |
| | | id to jump to with a delay between the jump. | |
| | | See section “Sequence file” in this document. | |
| | | File is passed without path and is found in the | |
| | | <webroot> directory. | |
| | | Example: | |
| | | Mysequence.asq | |
| | 6 | Hyperlink to open in a new browser. | |
| | | Must include the http:// | |
| | | Example: | |
| | | http://www.avu3d.com | |

| | |
|---|---|
| | For all other action, PARAM2 is empty |
| IMAGE | Name of the image to display on the zone. |
| | This image is found in the following directory: |
| | <webroot>WEB_AVUProject\LINKIMGS |
| | Note: |
| | An image name that include “_on” or “_off” in is name means that |
| | the link must displayed the image with the “_off” in it when mouse |
| | isn't over the zone and displayed the image with “_on” when mouse |
| | is over the zone. The two images are found in the same folder. |
| | Example: |
| | BtnMybutton_on.png |
| GROUP | Reserved |
| LABEL | UTF-8 Label representing the links. This label must be displayed in |
| | mobile or flash player in a menu to invoke the corresponding action for |
| | global links. |
| | For local links (associated to a given image), this label is never use. |
| | This label is Multilanguage (see Language Section) |

In one embodiment, the 3D environment is generated automatically by inputting a set of images into a software application. The application is configured to request information needed to geo-reference the images together and generate the 3D environment accordingly.

Once completed, the 3D environment is represented by the configuration file describing the environment and another file describing the 3D space.

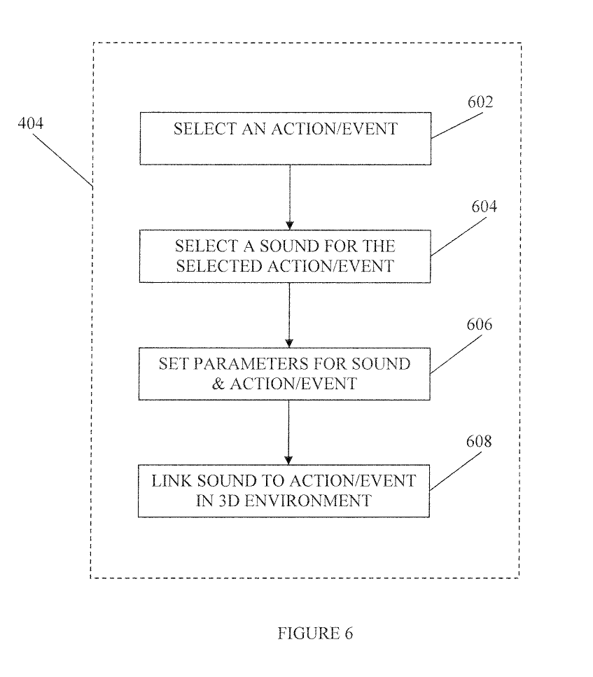

FIG. 6 is a flowchart detailing step 404 of adding sound to a 3D environment. An action/event is first selected 602. Similarly to the links described above, the action/event may be an input command for a given direction, or it may correspond to a given position in the image. For example, a position might be near a fireplace or an open window. The event would then be the user reaching this given position in the view. The action could be advancing throughout the image. Other examples of actions or events will be readily understood.

A sound is selected for the selected action/event 604. For example, if the action is having the user advancing in the 3D environment, the sound may be footsteps. If the event is having a user reach a given position while navigating, such as the fireplace or the open window, the sound may be crackling fire or birds chirping, respectively. Various possible combinations or actions/events and sounds may be made available to the user via a database. Alternatively, the user may record a sound and use the recorded sound as desired. The sound may be a natural sound found in a given environment, outside or inside, or it could be the voice of a person speaking about the special's of the day (in a restaurant), rebates, products, etc.

Certain parameters may be set for the sound and associated action/event 606. For example, timing, volume, and other preferences may be preselected. Finally, the sound and associated action/event are linked to the 3D environment 608 such that the 3D environment and the sound environment are fully integrated.

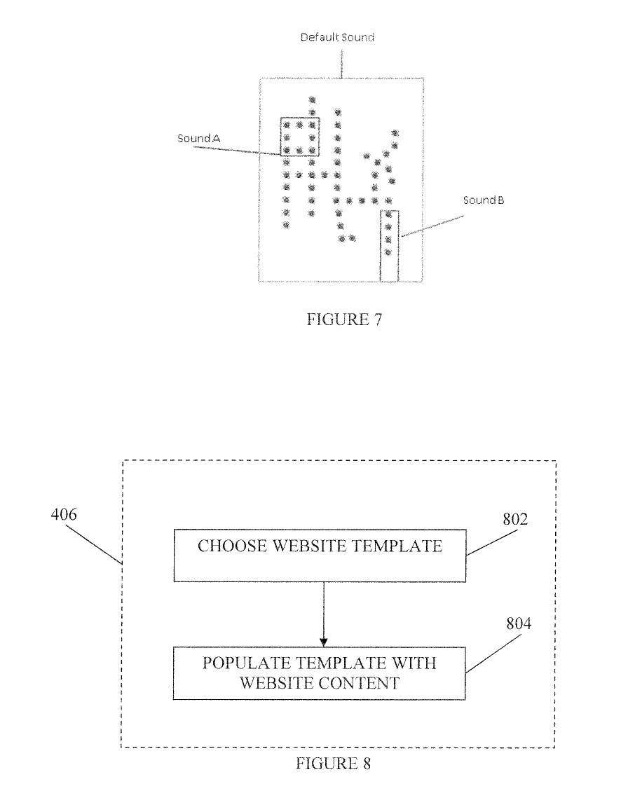

FIG. 7 illustrates the concept of adding sound to the 3D environment using sound zones. Since the 3D environment is made up of a plurality of regrouped images disposed in a 3D space, the sound effects may be associated with zones or areas made up of the images, as defined by the user. The dots in FIG. 7 correspond to the images. The “default sound” rectangle defines a zone for a given default sound effect, such as background music. This sound effect will play permanently for all images in the zone. The “sound A” and “sound B” rectangles define other zones where a particular sound is to be played when the user is positioned in one of these images. For example, the “sound A” images may correspond to a kitchen and sound A may correspond to chirping birds outside a window, while the “sound B” images may correspond to a living room and sound B may correspond to crackling fire in a fireplace.

Table 3 is an exemplary listing of possible parameters used to define sound zones.

TABLE 3

| Parameter | Description |
|---|---|
| X, Y | X, Y coordinates of upper left hand |
| | corner. |
| W | Width of the zone. |
| H | Height of the zone. |
| SOUND NAME | Name of sound media file (mp3, wav, |
| | etc). |
| FADE IN | Duration of fade in. |
| FADE OUT | Duration of fade out. |
| LOOP | Sound played in a loop. |
| VOLUME | Volume of sound (1: min to 10: max). |
| ONE SHOT | The sound is played only once during |
| | the entire visit. |

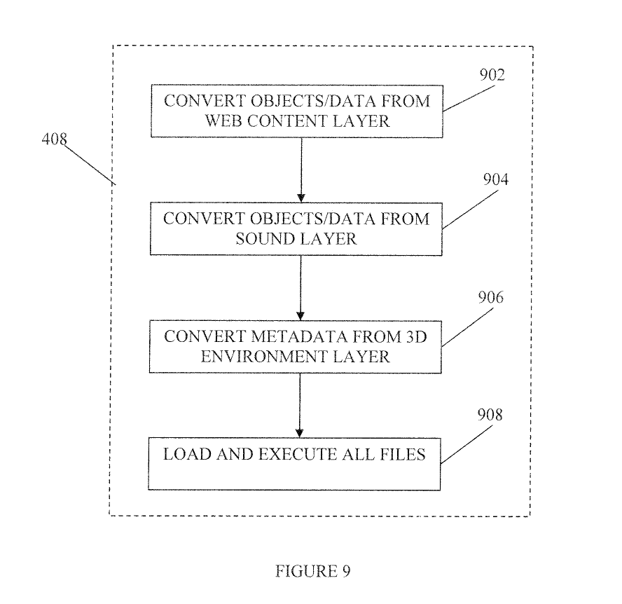

FIG. 8 illustrates in detail the step of customizing website content 406 from FIG. 4. In a first step, the user may select a template 802 from a plurality of available templates. The templates may vary with respect to the layout of the website, namely the positioning of menus and hyperlinks (or other forms of indexing information), the number of total web pages interconnected, and how to navigate from one web page to another. In one embodiment choosing a website template means creating a template from scratch, in accordance with the user's own preferences.

The website template is populated with website content 804. The content may be audio, video, or text and will vary from user to user, in accordance with the purpose of the website. For example, a website for a company selling products will have information on the products in question. A website for a restaurant may have information regarding the menu, the opening hours, the different locations, etc. Any content found on any website may be provided in the virtual 3D environment website. Once the template is populated, the 3D environment, sound environment, and web content are ready to be integrated.

The set of elements making up the website are objects separate from the 3D environment. These objects reside on a virtual logic layer overlaid on top of the 3D environment. These objects may be linked together and can also be linked to specific actions or events (such as mouse clicks, cursor movement, etc).

The objects may be defined by data structures that respond similarly to typical objects or elements in a website, but with two added attributes: (1) they are global to the entire 3D content (i.e. displayed on every image) and (2) they are part of a set of objects for the web content overlaid on top of the 3D environment.

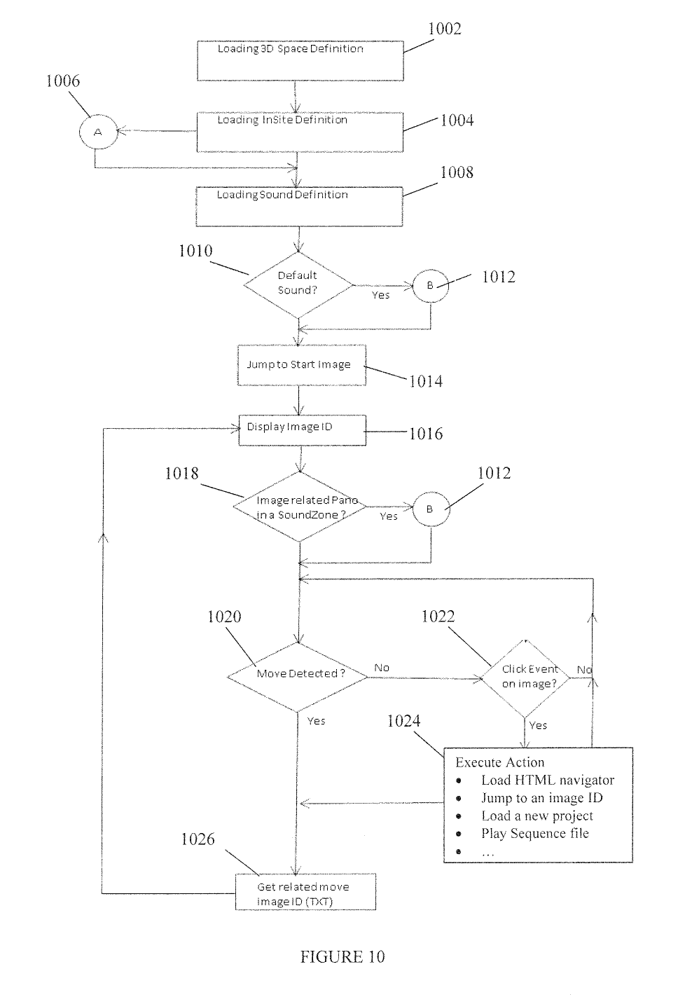

FIG. 9 illustrates in detail step 408 of integrating the 3D environment, sound environment and web content from FIG. 4. In a first step 902, objects/data from the web content layer are structurally converted to a readable and usable format for external applications. In one embodiment, a file format compatible with JavaScript Object Notation (JSON) is used. For illustrative purposes, the file generated will be called a first “.JSON” file. This file describes the web content layer.

In a second step 904, objects/data from the sound environment layer are structurally converted to a readable and usable format. The JSON format may again be used, thereby generating a second “.JSON” file. This file describes the sound environment layer.

In a third step 906, metadata from the 3D environment layer is structurally converted to a readable and usable format. The JSON format may yet again be used, thereby generating a third “.JSON” file. This file describes the 3D space in which the images reside. The configuration file, as described above, describes the 3D environment more generally. Information regarding the size and position of the images, presence/position of markers on the images, starting image ID, total number of images, and a description of global links in the 3D environment can be found in the configuration file. Together, the third “.JSON” file and the configuration file describe the 3D environment layer.

Once all three “.JSON” files have been generated, they are sequentially loaded (with the configuration file) and subsequently executed 908. In one embodiment, the sequence followed for loading the files is as follows: 3D environment layer (configuration file and .JSON file), web content layer, sound layer. It should be understood that other formats such as XML, OGDL, YAML and CSV, may be used instead of, or in combination with, the JSON standard.

In one embodiment, users may add content and/or modify existing content via the .JSON files. A Web user interface (developed in PHP, ASP, or other) may be used to perform these changes to the content of the 3D virtual website. These interfaces are external to the engine running the actual 3D virtual website.

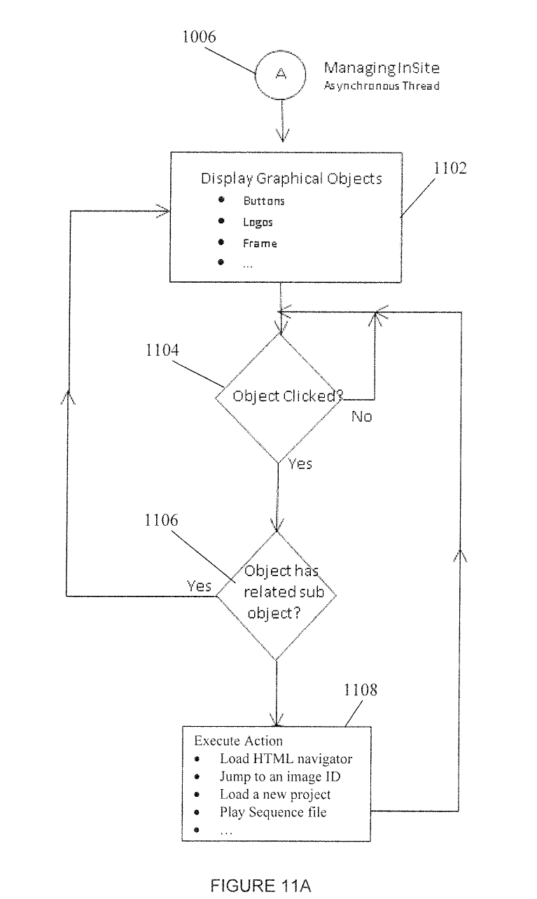

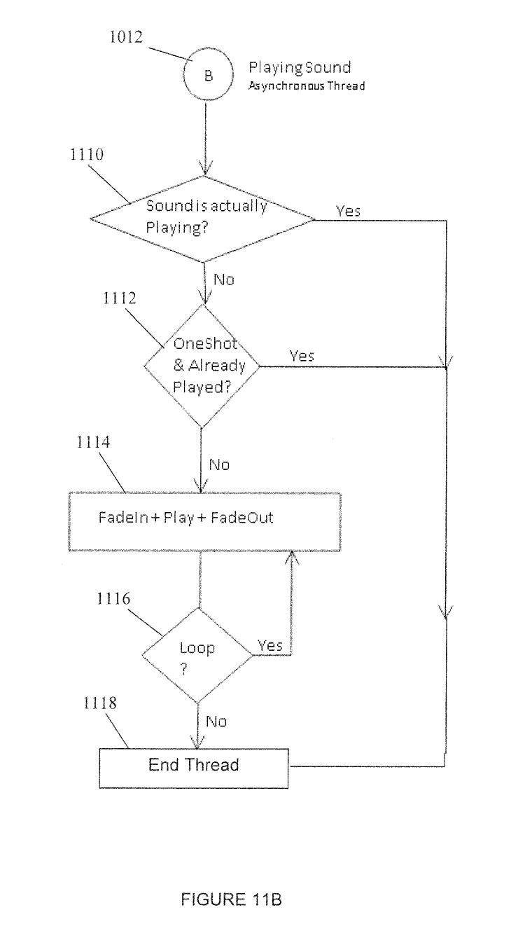

FIG. 10 illustrates in more detail the process of FIG. 9, as well as what happens post-execution of the files. As illustrated, multiple threads may be run in parallel. Each of the 3D space definition 1002, the web content definition 1004, and the sound definition 1008 files are loaded. After loading the website content files 1004, process “A” 1006 may be run asynchronously and in parallel with the main process. Process “A” 1006 is illustrated in FIG. 11a and relates to managing events related to the objects/data in the website content layer. The events may correspond to mouse clicks on various objects that cause the display of other objects, such as dialog boxes, content boxes, etc, or they may correspond to other events in the main process. Process “B” is illustrated in FIG. 11b and relates to managing the various sounds. This process is entered in the case of default sounds 1010 and may end independently in the case of a “ONE SHOT” sound, or it may keep looping around for a “LOOP” sound. Other sound processes may be added as needed.

Once all of the files are loaded, a start page is displayed 1014. The first 2D image used for the 3D virtual environment may be predetermined as always being the same one, or it may be set as a function of various parameters selected by the user. For example, on a website offering a virtual visit of a house, the virtual 3D environment may be created only after the user selects which room to start the virtual visit in. The first 2D image would therefore depend on which room is selected. In this case, instructions to retrieve the first 2D image may include specifics about which image should be retrieved. Alternatively, the first 2D image may be retrieved as per predetermined criteria.

For each image displayed, the 3D coordinates of the image is validated with each sound zone 1018. If the image is part of a sound zone, the “B” process 1012 is run in order to play the sound associated with the given sound zone, in accordance with the predetermined parameters. Navigation of the virtual 3D website may continue due to the asynchronous nature of the parallel processes. Movement of the user within the 3D environment is detected 1020 and causes a new image to be retrieved 1026 and displayed 1016. The process continues to loop back. If no move is detected 1020 but a click event on an image occurs 1022, the action associated with the event is executed 1024. Some exemplary actions are listed in the figure, such as loading an HTML navigator, jumping to an image ID, loading a new project, playing a sequence file, etc.

FIG. 11a illustrates in more detail process A 1006 for managing events related to the objects/data in the website content layer. Various graphical objects may be displayed 1102, such as buttons, logos, frames, etc. If an object click is detected 1104, the process will either first determine if the object has any related sub-objects associated thereto 1106 and will execute an action 1108 and display graphical objects for the sub-object 1102. As per FIG. 11b, when entering the sound management process 1012, a determination is first made as to whether sound is actually playing 1110. If so, the process may end immediately 1118. If not, a determination is made as to whether the requested sound should only be a “one shot” sound 112, i.e. a short discrete sound. For a longer sound, a fade-in, play, and fade-out sequence is run 1114. This sequence may be looped 1116 one or more times. Once looping is complete, the process ends 1118.

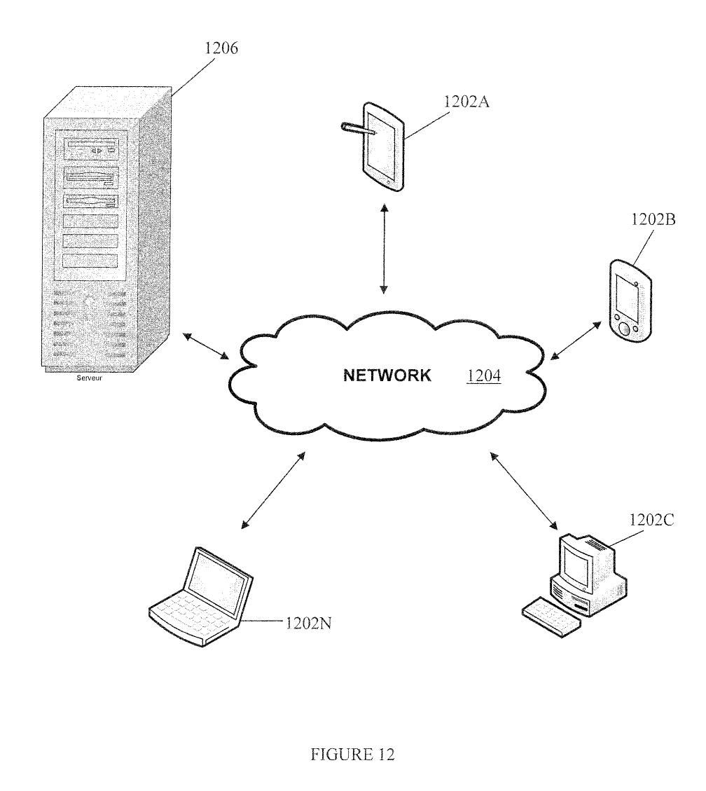

FIG. 12 illustrates a network for creating the virtual 3D environment website, as well as for accessing it. A plurality of user devices 1202a, 1202b, 1202c, 1202n are connected through a network 1204 such as the Internet to a web server 1206. Any one of the user devices 1202a, 1202b, 1202c, 1202n may be used to create the virtual 3D environment website. The images used for the 3D environment may be accessible on the web server 1206 or may be uploaded onto the web server 1206 at the time of creation of the virtual 3D environment website. The sounds, actions/events, and website templates may also be accessible on the web server 1206 or uploaded in real time, where the information may be stored directly thereon or on an operatively connected database.

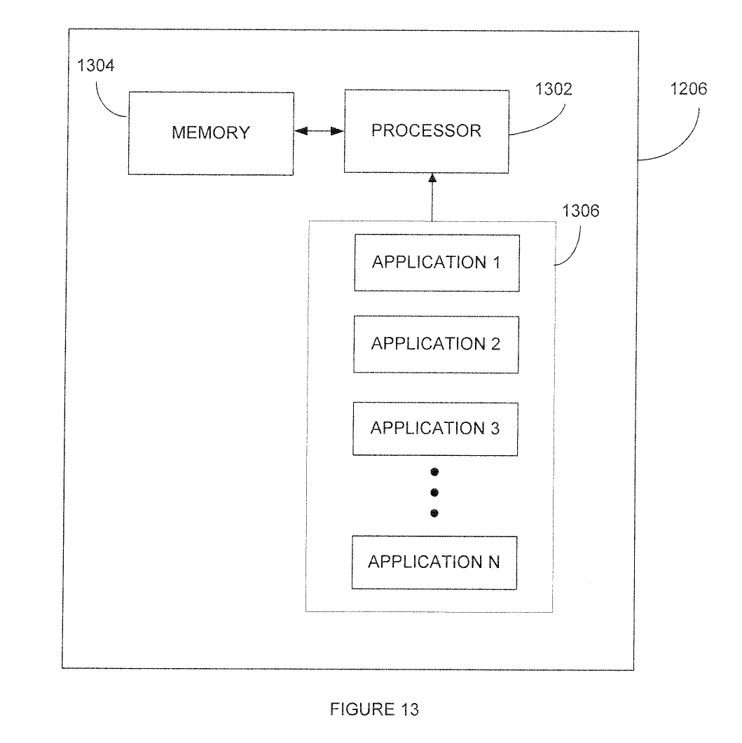

The web server 1206 comprises a processor 1302, a memory 1304 accessible by the processor 1302, and at least one application 1306 coupled to the processor 1302, as illustrated in FIG. 13. The application 1306 is configured to load and execute at least a first file of data describing a configuration of the three-dimensional environment and a position of the plurality of images in a 3D space. The application 1306 is also configured to load and execute at least a second file of data describing sound parameters for the plurality of images in the three-dimensional environment, the sound parameters defining at least one sound zone comprising at least one of the plurality of images. The application 1306 is also configured to load and execute at least a third file of data comprising elements making up the website content, the elements being separate from the three-dimensional environment and global to the plurality of images. In response to a request, the application 1306 will display the virtual three-dimensional environment on one or more of user devices 1202a, 1202b, 1202c, 1202n with the website content overlaid on top thereof, and activate a sound when a user is navigating the at least one of the plurality of images in the at least one sound zone in accordance with the sound parameters.

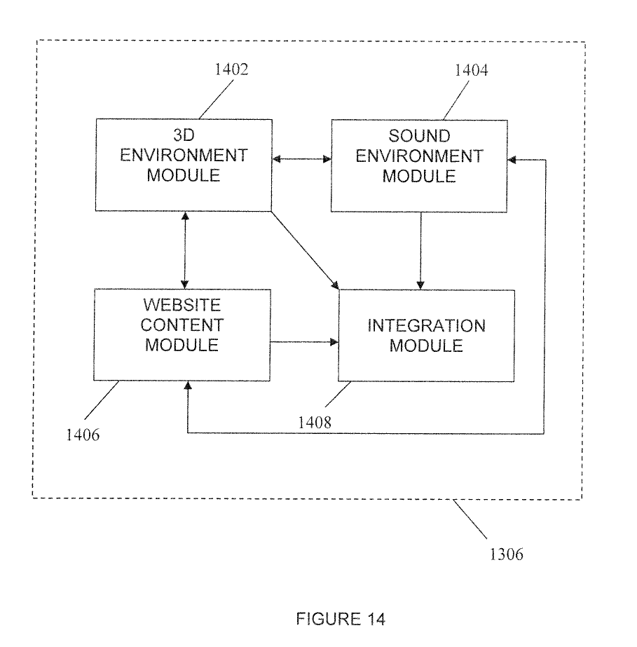

The user creates the various layers of the virtual 3D environment website as described above by accessing the web server 1206 and once generated, the website becomes available to the public using any one of user devices 1202a, 1202b, 1202c, 1202n and network 1204. The user can, at anytime, modify the content of the virtual 3D environment website by making changes to the 3D environment, sound environment, and/or web content. FIG. 14 is an exemplary embodiment of the application 1306 running on the web server 1206. A three-dimensional environment module 1402 is provided to build the three-dimensional environment. This is done with the two-dimensional images and the set of predetermined moves for navigation, as described above. A sound environment module 1404 is used for creating the sound environment. The various sound zones are associated with images and/or website content. A website content module 1406 is used for customizing the website content, i.e. determining layout, objects, etc. The three creation modules 1402, 1404, 1406 may communicate with each other. In certain instances, information from one module may be used for configuration in another module. For example, if the sound is linked to an image in the 3D environment, information regarding the images may be accessed by the sound environment module 1404 in the 3D environment module 1402. The three creation modules 1402, 1404, 1406 all feed into an integration module 1408, which is used to generate the 3D website by integrating the three-dimensional environment, the sound environment, and the website content together for display, whereby the website content is overlaid on top of the three-dimensional environment.

While the application 1306 may reside entirely on server 1206, it may also reside partially on server 1206 and partially on another remote computing device (not shown). Also alternatively, it may reside partially on server 1206 and partially on one of devices 1202A, 1202B, 1202C, 1202N. It may also reside entirely on one of devices 1202A, 1202B, 1202C, 1202N, while 2D images for building the 3D environment may be provided on a remote database, accessible by the devices 1202A, 1202B, 1202C, 1202N via network 1204. In addition, the separation of the various modules illustrated in FIG. 14 is for illustration purposes only. Program code executable by a processor for creating each of the components of the 3D website, i.e. 3D environment, sound environment, and website content, may be shared amongst two or more devices as appropriate for execution.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment. It should be noted that the present invention can be carried out as a method, can be embodied in a system, a computer readable medium or an electrical or electro-magnetic signal. The embodiments of the invention described above are intended to be exemplary only. The scope of the invention is therefore intended to be limited solely by the scope of the appended claims.

1. A computer-implemented method for generating a 3D website having a virtual three-dimensional environment composed of a plurality of images navigable in an immersive manner, website content, and sound, the method comprising executing on a processor program code for:
building the three-dimensional environment with a plurality of two-dimensional images corresponding to views of the environment placed in a 3D space based on x, y, z coordinates, the plurality of images having a set of predetermined moves for navigation associated thereto;
creating a sound environment for the three-dimensional environment by associating at least one sound zone with at least one part of at least one of the plurality of images, and setting sound parameters for each of the at least one sound zone;
customizing website content separate from the images of the three-dimensional environment and configured to appear on at least one of the plurality of images; and
generating the 3D website by integrating the three-dimensional environment, the sound environment, and the website content together for display, whereby the website content is overlaid on top of the three-dimensional environment.

2. The method of claim 1, wherein customizing the website content comprises populating a template with the content.

3. The method of claim 1, wherein customizing the website content comprises linking the website content to navigation to at least one of the plurality of images.

4. The method of claim 1, wherein customizing the website content comprises linking the website content to navigation within the at least one of the plurality of images.

5. The method of claim 1, wherein customizing the website content comprises setting a layout for the website content, the layout comprising disposition of at least one of hyperlinks, menus, frames, logos, and content boxes.

6. The method of claim 1, wherein building the three-dimensional environment comprises retrieving the plurality of two-dimensional images and automatically generating the three-dimensional environment.

7. The method of claim 1, wherein creating the sound environment comprises associating at least a first sound zone with a first set of the plurality of images and at least a second sound zone with a second set of the plurality of images.

8. The method of claim 1, wherein setting the sound parameters comprises associating at least one sound with a user action caused by navigating within the three-dimensional environment.

9. The method of claim 8, wherein the user action is at least one of a given position in an image and a given image being displayed.

10. The method of claim 1, wherein setting the sound parameters comprises associating at least one sound with a user action caused by navigating within the website content.

11. A system for generating a 3D website having a virtual three-dimensional environment composed of a plurality of images navigable in an immersive manner, website content, and sound, the system comprising:
at least one computing device having a processor and a memory;
a three-dimensional environment module stored on the memory and executable by the processor, the three-dimensional environment module having program code that when executed, builds the three-dimensional environment with a plurality of two-dimensional images corresponding to views of the environment placed in a 3D space based on x, y, z coordinates, the plurality of images having a set of predetermined moves for navigation associated thereto;
a sound environment module stored on the memory and executable by the processor, the sound environment module having program code that when executed, creates a sound environment for the three-dimensional environment by associating at least one sound zone with at least one part of at least one of the plurality of images, and setting sound parameters for each of the at least one sound zone;
a website content module stored on the memory and executable by the processor, the website content module having program code that when executed, customizes the website content separate from the images of the three-dimensional environment and configured to appear on at least one of the plurality of images; and
an integration module stored on the memory and executable by the processor, the integration module having program code that when executed, generates the 3D website by integrating the three-dimensional environment, the sound environment, and the website content together for display, whereby the website content is overlaid on top of the three-dimensional environment.

12. The system of claim 11, wherein the website content module further comprises program code that when executed, populates a template with the content.

13. The system of claim 11, wherein the website content module further comprises program code that when executed, links the website content to navigation to at least one of the plurality of images.

14. The system of claim 11, wherein the website content module further comprises program code that when executed, links the website content to navigation within the at least one of the plurality of images.

15. The system of claim 11, wherein the website content module further comprises program code that when executed, sets a layout for the website content, the layout comprising disposition of at least one of hyperlinks, menus, frames, logos, and content boxes.

16. The system of claim 11, wherein the three-dimensional environment module further comprises program code that when executed, retrieves the plurality of two-dimensional images and automatically generates the three-dimensional environment.

17. The system of claim 11, wherein the sound environment module further comprises program code that when executed, creates the sound environment by associating at least a first sound zone with a first set of the plurality of images and at least a second sound zone with a second set of the plurality of images.

18. The system of claim 11, wherein the sound environment module further comprises program code that when executed, sets the sound parameters by associating at least one sound with a user action caused by navigating within the three-dimensional environment.

19. The system of claim 18, wherein the user action is at least one of a given position in an image and a given image being displayed.

20. The system of claim 11, wherein the sound environment module further comprises program code that when executed, sets the sound parameters by associating at least one sound with a user action caused by navigating within the website content.

21. A computer readable medium having stored thereon program code executable by a processor for generating a 3D website having a virtual three-dimensional environment composed of a plurality of images navigable in an immersive manner, website content, and sound, the program code executable for:
building the three-dimensional environment with a plurality of two-dimensional images corresponding to views of the environment placed in a 3D space based on x, y, z coordinates, the plurality of images having a set of predetermined moves for navigation associated thereto;
creating a sound environment for the three-dimensional environment by associating at least one sound zone with at least one part of at least one of the plurality of images, and setting sound parameters for each of the at least one sound zone;
customizing website content separate from the images of the three-dimensional environment and configured to appear on at least one of the plurality of images; and
generating the 3D website by integrating the three-dimensional environment, the sound environment, and the website content together for display, whereby the website content is overlaid on top of the three-dimensional environment.
